(19) United States
(12) Patent Application Publication
(10) Pub. No.: US 2007/0002260 A1
(43) Pub. Date: Jan. 4, 2007

(54) Liquid crystal display

(75) Inventor: Seong-Sik Choi, Suwon-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/374,267

(22) Filed: Mar. 13, 2006

(30) Foreign Application Priority Data
Jun. 30, 2005 (KR) 10-2005-0057877

(51) Int. Cl. G02F 1/1339

(52) U.S. Cl. 349/155

(57) ABSTRACT

A liquid crystal display (LCD) is provided, the LCD includes a first insulating substrate, a second insulating substrate facing the first insulating substrate, a first field-generating electrode that is formed on the first substrate, a second field-generating electrode that is formed on the second substrate and that defines a plurality of pixels arranged substantially in a matrix, a liquid crystal layer interposed between the first substrate and the second substrate, and a plurality of spacers that are formed on one of the first substrate and the second substrate to maintain a distance between the two substrates, wherein the spacers are alternately disposed in a first interval and a second interval in every row of the matrix.

### CROSS-REFERENCE TO RELATED PATENT APPLICATION

This application claims priority to Korean Patent Application No. 2005-0057877, filed on Jun. 30, 2005, in the Korean Intellectual Property Office, the disclosure of which is incorporated by reference herein in its entirety.

### BACKGROUND OF THE INVENTION

1. Technical Field

The present invention relates to a liquid crystal display (LCD), and more particularly, to an LCD including a pair of panels and spacers for maintaining a uniform distance between the panels.

2. Discussion of the Related Art

Liquid crystal displays (LCDs) are among the most widely used flat panel display devices. For example, LCDs are found in a majority of battery powered flat panel display devices because they are relatively easy to manufacture and because they consume small amounts of electric power.

Generally, an LCD includes a pair of panels with field-generating electrodes on their inner surfaces. The panels are typically separated from each other by spacers. A space (e.g., a cell gap) between the panels is filled with LC molecules. In the LCD, a variation of a voltage difference between the field-generating electrodes (e.g., a variation in the strength of an electric field generated by the electrodes) changes the transmittance of light passing through the LCD, and thus desired images are obtained by controlling the voltage difference between the electrodes.

In general, the field-generating electrodes are individually formed on the panels. One of the panels, for example, a thin film transistor (TFT) array panel, contains interconnecting wiring, such as gate lines, data lines, etc., and TFTs. Each TFT serves as a switch for a pixel. In other words, the TFTs control data signals that are transmitted to pixel electrodes of pixels defined by intersections of the gate lines and the data lines. The other panel, for example, a common electrode panel, contains a common electrode on the entire area of one surface facing the pixel electrodes of the TFT array panel, and a black matrix with aperture regions facing the pixels of the TFT array panel.

In the LCD, the spacers insure that the panels remain separated by a certain distance over the entire display area. There are three types of spacers, they are: a bead spacer, a column spacer, and a rigid spacer. Of these, the column spacers are formed in a fixed pattern. To produce the column spacers, a photoresist layer is first formed on the common electrode panel. Then light exposure and development processes are successively performed, thereby completing the column spacers. The column spacers are then formed in portions of the pixels, where light is blocked, e.g., in portions corresponding to the TFTs, the gate lines, the storage electrode lines, etc., to a desired pattern.

Depending on the driving method of the LCD, the column spacers may cause undesired stripes in the display of the LCD, thereby degrading the display quality. As such, a need exists for a technique of forming column spacers in an LCD such that the display quality is enhanced.

### SUMMARY OF THE INVENTION

According to an aspect of the present invention, an LCD is provided that includes a first insulating substrate, a second insulating substrate facing the first insulating substrate, a first field-generating electrode that is formed on the first substrate, a second field-generating electrode that is formed on the second substrate and that defines a plurality of pixels that are arranged substantially in a matrix, a liquid crystal layer interposed between the first substrate and the second substrate, and a plurality of spacers that are formed on one of the first substrate and the second substrate to maintain a distance between the first and second substrates, wherein the spacers are alternately disposed in a first interval and a second interval in every row of the matrix.

The spacers may be disposed only at pixels corresponding to multiples of two different numbers that are selected from multiples of three. Here, the first interval may be an interval of six pixels, while the second interval may be an interval of nine pixels. Also, spacers of adjacent rows may be placed in different columns of the matrix.

The LCD may further include a plurality of red, green, and blue color filters that are formed on one of the first substrate and the second substrate. In this case, the spacers may be formed in regions corresponding to the blue filters, and the LCD may operate by 1+2 dot inversion.

The LCD may further include a gate line formed on the first substrate, a data line formed on the first substrate, a TFT that is connected to the gate line, the data line, and the first field-generating electrode, a first domain-partitioning member formed on the first substrate, and a second domain-partitioning member formed on the second substrate.

In this case, the first domain-partitioning member may be a cutting portion formed in the first field-generating electrode and the second domain-partitioning member may be a cutting portion formed in the second field-generating electrode, and may be formed about ±45 degrees to the gate line.

Otherwise, the first domain-partitioning member may be a protrusion formed in the first field-generating electrode and the second domain-partitioning member may be a protrusion formed in the second field-generating electrode.

The spacers may be column spacers. The spacers may be formed in regions corresponding to one of the gate line and the data line, or in regions corresponding to portions of the pixels surrounded with the gate line and the data line.

The first field-generating electrode may be a pixel electrode and the second field-generating electrode may be a common electrode.

According to another aspect of the present invention, an LCD is provided that includes a first insulating substrate, a plurality of gate lines formed on the first substrate, a plurality of data lines that are formed on the first substrate and crossed with the gate lines to define pixels that are arranged in a matrix, a plurality of TFTs, each of which is connected to one of the gate lines and one of the data lines, and a plurality of pixel electrodes, each of which is connected to one of the TFTs. The LCD further includes a second insulating substrate, a light-blocking member formed on the second substrate, a plurality of color filters formed on the light-blocking member, a common electrode formed on the color filters, and a plurality of spacers that are formed on one of the first substrate and the second substrate to maintain a uniform distance between the first and second substrates. The spacers are alternately disposed in a first interval and a second interval in every row of the matrix.

The spacers may be disposed only at pixels corresponding to multiples of two different numbers that are selected from multiples of three, and the first interval may be an interval of six pixels and the second interval may be an interval of nine pixels. Spacers of adjacent rows may be placed in different columns of the matrix.

The spacers may be formed in regions corresponding to the gate lines or the data lines, or in regions corresponding to portions of the pixels surrounded with the gate lines and the data lines.

### BRIEF DESCRIPTION OF THE DRAWINGS

The above and other features of the present invention will become more apparent by describing in detail exemplary embodiments thereof with reference to the accompanying drawings.

FIG. 1 is a layout view of a TFT array panel employed in an LCD according to an exemplary embodiment of the present invention.

FIG. 2 is a layout view of a common electrode panel employed in an LCD according to an exemplary embodiment of the present invention.

FIG. 3 is a layout view of an LCD incorporating the TFT array panel of FIG. 1 and the common electrode panel of FIG. 2.

FIG. 4 is a cross-sectional view taken along line IV-IV′ of FIG. 3.

FIG. 5 illustrates textures generated near column spacers according to another exemplary embodiment of the present invention.

FIG. 6A shows polarities of column spacers arranged at intervals of six pixels in a row direction and polarities of pixels when an LCD operates by 1+2 dot inversion.

FIG. 6B shows stripes originating from the arrangement of FIG. 6A.

FIG. 7A shows polarities of column spacers arranged at intervals of nine pixels in a row direction and polarities of pixels when an LCD operates by 1+2 dot inversion.

FIG. 7B shows stripes originating from the arrangement of FIG. 7A.

FIG. 8 shows polarities of column spacers, alternately arranged at an interval of six pixels and at an interval of nine pixels in a row direction, and polarities of pixels when an LCD operates by 1+2 dot inversion.

FIG. 9 is a layout view of an LCD according to another exemplary embodiment of the present invention.

FIG. 10 is a cross-sectional view taken along line X-X′ of FIG. 9.

FIG. 11 is a cross-sectional view of an LCD according to still another exemplary embodiment of the present invention.

### DETAILED DESCRIPTION OF EXEMPLARY EMBODIMENTS

The present invention will now be described more fully hereinafter with reference to the accompanying drawings, in which exemplary embodiments of the invention are shown. The present invention may, however, be embodied in different forms and should not be construed as being limited to the embodiments set forth herein. Rather, these embodiments are provided so that this disclosure will be thorough and complete, and will fully convey the scope of the invention to those skilled in the art.

In the drawings, the thickness of layers, films, and regions are exaggerated for clarity. Like numerals refer to like elements throughout. It will be understood that when an element such as a layer, film, region, or substrate is referred to as being “on” another element, it can be directly on the other element or intervening elements may also be present.

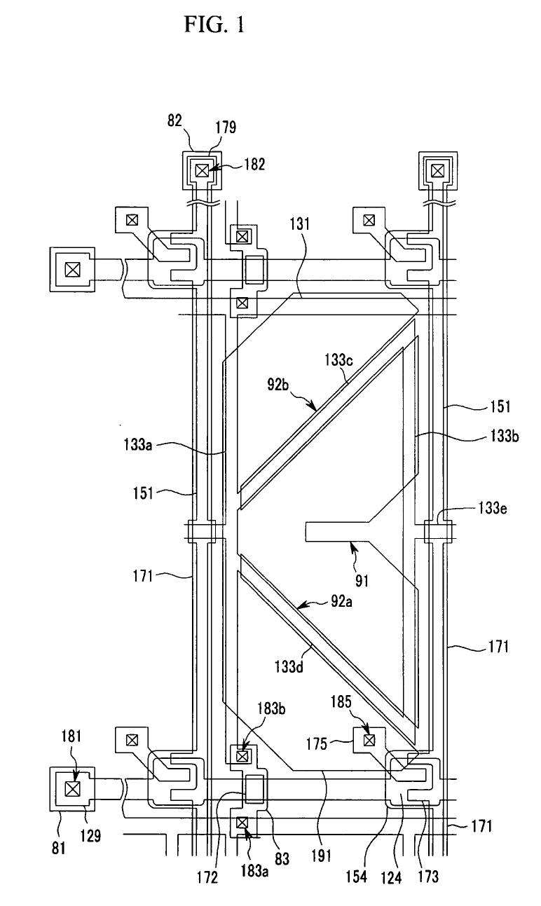

Hereinafter, a multi-domain LCD according to an exemplary embodiment of the present invention will be described with reference to FIG. 1 through FIG. 4.

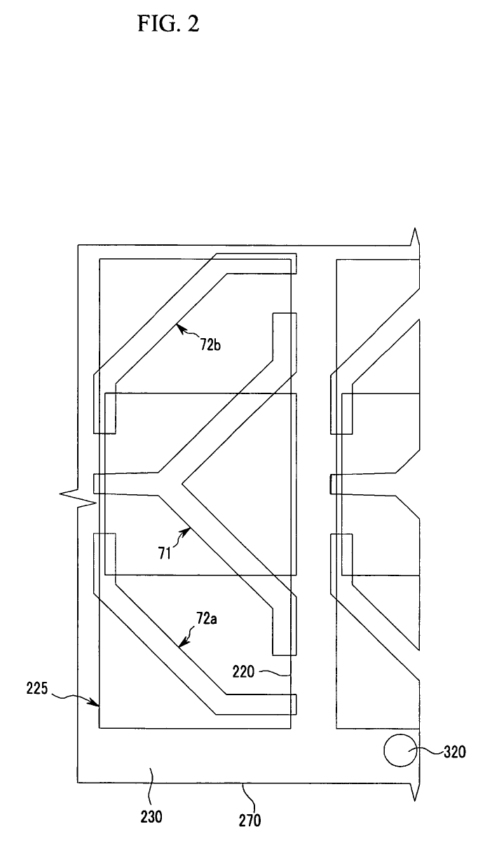

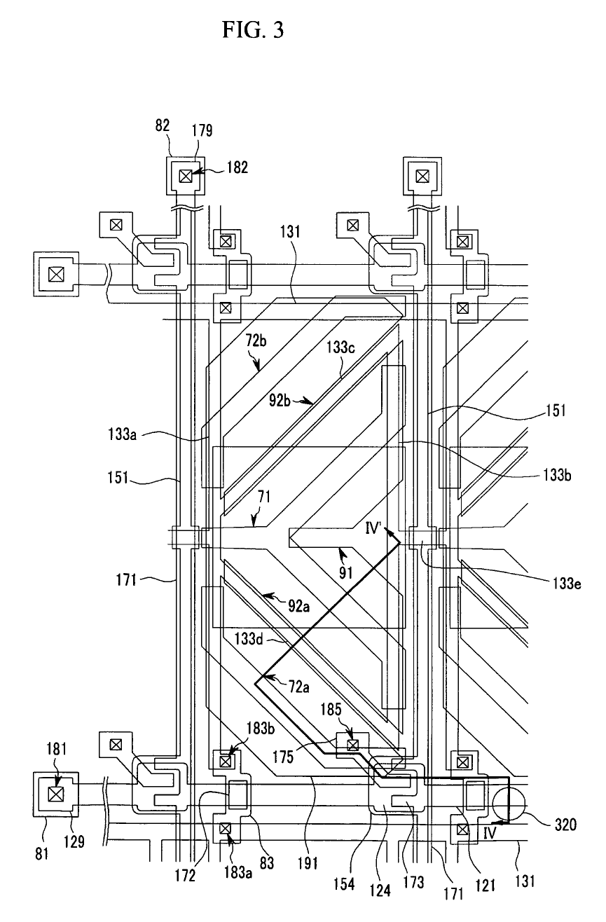

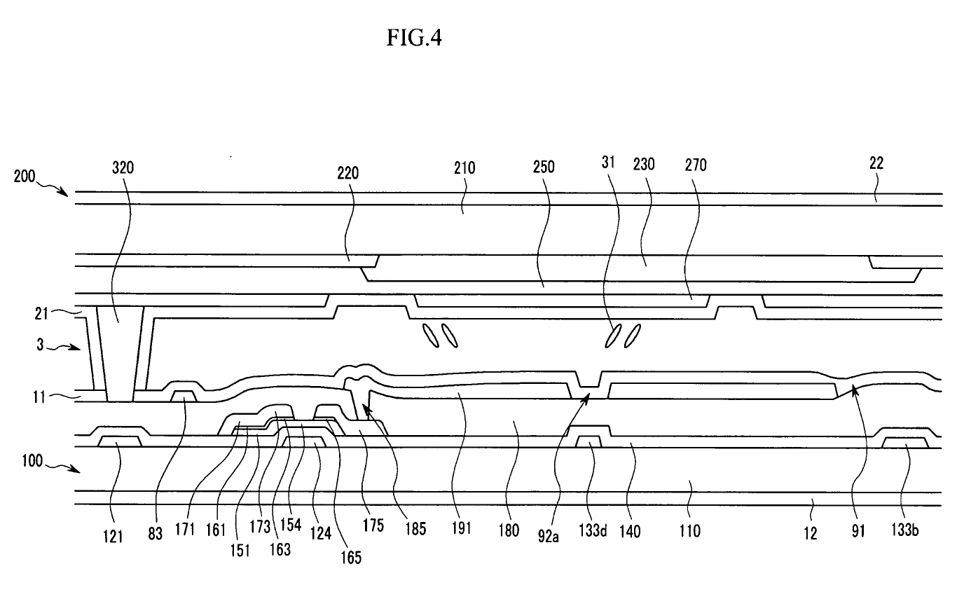

FIG. 1 is a layout view of a TFT array panel employed in an LCD according to an embodiment of the present invention, FIG. 2 is a layout view of a common electrode panel employed in an LCD according to an embodiment of the present invention, FIG. 3 is a layout view of an LCD incorporating the TFT array panel of FIG. 1 and the common electrode panel of FIG. 2, and FIG. 4 is a cross-sectional view taken along line IV-IV′ of FIG. 3.

Referring to FIG. 1 through FIG. 4, an LCD according to an embodiment of the present invention comprises a TFT array panel 100 and a common electrode panel 200 facing each other, and an LC layer 3 interposed therebetween.

The TFT array panel 100 is first described with reference to FIG. 1, FIG. 3, and FIG. 4.

A plurality of gate lines 121 and a plurality of storage electrode lines 131 are formed on an insulating substrate 110 made of transparent glass or plastic.

The gate lines 121 for transmitting gate signals extend substantially in a horizontal direction. Each gate line 121 includes a plurality of gate electrodes 124 protruding upward, and an end portion 129 having a relatively large size to be connected to a different layer or an external device. Gate drivers (not shown) for generating the gate signals may be mounted on a flexible printed circuit film (not shown) attached to the substrate 110, or directly on the substrate 110. Otherwise, the gate drivers may be integrated into the substrate 110. In this case, the gate lines 121 are directly connected to the gate drivers.

The storage electrode lines 131 receive a predetermined voltage. Each storage electrode line 131 includes: a stem line that is substantially parallel to the gate lines 121; multiple groups of storage electrodes 133a, 133b, 133c, and 133d; and a plurality of connecting parts 133e. Each storage electrode line 131 is placed between two adjacent gate lines 121, and the stem line of one the storage electrode lines 131 is closer to the upper gate line of the two. First storage electrodes 133a and second storage electrodes 133b extend in a vertical direction and are parallel to each other. Each first storage electrode 133a has a fixed end that is connected to one of the stem lines and a free end with a projection. Each third storage electrode 133c extends in the form of a slanted line that starts from a point close to the middle of the first storage electrode 133a and meets an upper end of the second storage electrode line 133b, while each fourth storage electrode 133d extends in the form of a slanted line that starts from another point close to the middle of the first storage electrode 133a and meets a lower end of the second storage electrode line 133b. It is to be understood, however, that the form and arrangement of the storage electrode lines 131 may be varied.

The gate lines 121 and the storage electrode lines 131 are made of an aluminum—(Al) containing metal such as Al and an Al alloy, a silver—(Ag) containing metal such as Ag and a Ag alloy, a copper—(Cu) containing metal such as Cu and a Cu alloy, a molybdenum—(Mo) containing metal such as Mo and a Mo alloy, chrome (Cr), titanium (Ti), or tantalum (Ta). The gate lines 121 and the storage electrode lines 131 may be configured as a multi-layered structure, in which at least two conductive layers (not shown) having different physical properties are included. In such a structure, one of the two conductive layers is made of a low resistivity metal, such as an Al-containing metal, a Ag-containing metal, a Cu-containing metal, or the like, to reduce a delay of the signals or voltage drop in the gate lines 121 and the storage electrode lines 131. The other layer is made of a material having good physical, chemical, and electrical contact properties with materials such as indium tin oxide (ITO) and indium zinc oxide (IZO). For example, a Mo-containing metal, Cr, Ta, Ti, etc., may be used for the formation of the layer. Other examples of the combination of the two layers are a lower Cr layer and an upper Al (or Al alloy) layer, and a lower Al (or Al alloy) layer and an upper Mo (or Mo alloy) layer. In addition to the above-listed materials, various metals and conductors can be used for the formation of the gate lines 121 and the storage electrode lines 131.

All lateral sides of the gate lines 121 and the storage electrode lines 131 slope in the range from about 30° to 80° to the surface of the substrate 110.

A gate insulating layer 140 made of nitride silicon (SiNx) or silicon oxide (SiO₂), is formed on the gate lines 121 and the storage electrode lines 131.

A plurality of linear semiconductors 151 made of hydrogenated amorphous silicon (abbreviated as “a-Si”) or polysilicon are formed on the gate insulating layer 140. Each linear semiconductor 151 extends substantially in a vertical direction, and includes a plurality of projections 154 that extend along respective gate electrodes 124. The linear semiconductors 151 are enlarged near the gate lines 121 and the storage electrode lines 131 by the projections 154 to cover them.

A plurality of linear ohmic contacts 161 and island-shaped ohmic contacts 165 are formed on the linear semiconductors 151. The ohmic contacts 161 and 165 may be made of N+ hydrogenated amorphous silicon that is highly doped with N-type impurities such as phosphorus (P), or silicide. The linear ohmic contacts 161 include a plurality of projections 163. A set of a projection 163 and an island-shaped ohmic contact 165 is placed on the projection 154 of the semiconductor 151.

All lateral sides of the linear semiconductors 151 and the ohmic contacts 161 and 165 slope in the range from about 30° to 80° to the surface of the substrate 110.

A plurality of data lines 171, a plurality of drain electrodes 175, and a plurality of metal pieces 172 are formed on the ohmic contacts 161 and 165 and the gate insulating layer 140.

The data lines 171 for transmitting data signals extend substantially in a vertical direction, and cross the gate lines 121, the storage electrode lines 131 and the connecting parts 133e. Each data line 171 includes a plurality of source electrodes 173 extending toward their respective gate electrodes 124, and an end portion 179 having a relatively large size to be connected to a different layer or an external device. Data drivers (not shown) for generating the data signals may be mounted on a flexible printed circuit film (not shown) attached to the substrate 110, or directly on the substrate 110. Otherwise, the data drivers may be integrated into the substrate 110. In this case, the data lines 171 are directly connected to the gate drivers.

The drain electrodes 175 are separated from the data lines 171 and are opposite the source electrodes 173 centering on the gate electrodes 124. Each drain electrode 175 includes an expansion having a relatively large size and a slightly curved bar-shaped end portion that is partially surrounded with the source electrode 173 having the shape of a “U” rotated 90° counter-clockwise.

A gate electrode 124, a source electrode 173, a drain electrode 175, and a projection 154 of the semiconductor 151 form a thin film transistor (TFT). A TFT channel is formed in the projection 154 provided between the source electrode 173 and the drain electrode 175.

Each metal piece 172 is disposed on a portion of the gate line 121, which is positioned closer to the projection of the free end of the first storage electrode 133a.

The data lines 171 and the drain electrodes 175 are made of a refractory metal such as Mo, Cr, Ta, or Ti, or alloys thereof, and may be configured as multi-layered structures including a refractory metal layer (not shown) and a low resistivity conductive layer (not shown). An example of the multi-layered structure is a lower layer made of one of Cr, Mo, and a Mo alloy, and an upper layer made of Al or an Al alloy. Another example is a lower layer made of Mo or a Mo alloy, an intermediate layer made of Al or a Al alloy, and an upper layer made of Mo or a Mo alloy. In addition to the above-listed materials, various metals and conductors can be used for the formation of the data lines 171 and the drain electrodes 175.

All lateral sides of the data lines 171 and the drain electrodes 175 slope in the range from about 30° to 80° to the surface of the substrate 110.

The ohmic contacts 161 and 165 exist only between the underlying semiconductors 151 and the overlying data lines 171 and between the overlying drain electrodes 175 and the underlying semiconductors 151, to reduce contact resistance therebetween. Most portions of the linear semiconductors 151 are formed more narrowly than the data lines 171, but some portions thereof are enlarged in areas to be crossed with the gate lines 121 or the storage electrode lines 131, to prevent the data lines 171 from disconnecting. The linear semiconductors 151 are partially exposed in areas where the data lines 171 and the drain electrodes 175 do not cover them, as well as between the source electrodes 173 and the drain electrodes 175.

A passivation layer 180 is formed on the data lines 171, the drain electrodes 175, and the exposed portions of the semiconductors 151. A top surface of the passivation layer 180 may be flat. The passivation layer 180 may be configured as a single layer made of an inorganic insulator, such as SiNx or SiO₂, or an organic insulator. In this case, an organic insulator for the passivation layer 180 has a low dielectric constant of below 4.0 and/or photosensitivity. The passivation layer 180 may also be configured as a double-layered structure including a lower inorganic insulator layer and an upper organic insulator layer. This doubled-layered structure has a good insulating property, and protects the exposed portions of the semiconductors 151 from damage.

The passivation layer 180 is provided with a plurality of contact holes 182 and 185, through which the end portions 179 of the data lines 171 and the expansions of the drain electrodes 175 are exposed, respectively. A plurality of contact holes 181 are formed in the passivation layer 180 and the gate insulating layer 140, and the end portions 129 of the gate lines 121 are exposed therethrough. A plurality of contact holes 183a and 183b are also formed in the passivation layer 180 and the gate insulating layer 140 to expose the portions of the stem lines of the storage electrode line 131, which are adjacent to the fixed ends of the first storage electrode lines 133a, and the projections of the free ends of the first storage electrodes 133a therethrough.

A plurality of pixel electrodes 191, a plurality of overpasses 83, and a plurality of contact assistants 81 and 82 are formed on the passivation layer 180. They may be made of a transparent conductor, such as ITO or IZO, or a reflective metal, such as Al, Ag, Cr, or their alloys.

The pixel electrodes 191 are physically and electrically connected to the drain electrodes 175 through the contact holes 185 to receive data voltages from the drain electrodes 175. The pixel electrodes 191 supplied with the data voltages generate electric fields in cooperation with a common electrode 270 of the common electrode panel 200, thereby determining the orientations of LC molecules 31 in the LC layer 3 interposed between the two electrodes 191 and 270. According to the orientations of the LC molecules 31, the polarization of light passing through the LC layer 3 is varied. Each set of the pixel electrode 191 and the common electrode 270 forms an LC capacitor that is capable of storing an applied voltage after the TFT is turned off.

The pixel electrodes 191 are overlapped with the storage electrodes 133a, 133b, 133c, and 133d as well as the stem lines of the storage electrodes 131. Left and right vertical sides of the pixel electrodes 191 are formed more closely to the data lines 171 than the first and second storage electrodes 133a and 133b. To enhance the voltage storage capability of the LC capacitors, storage capacitors are provided. The storage capacitors are implemented by overlapping the pixel electrodes 191 and the drain electrodes 175, electrically connected thereto, with the storage electrode lines 131.

Each pixel electrode 191 has a rectangular shape whose four corners are chamfered. Two vertical sides of the pixel electrode 191 are substantially parallel to the data lines 171, and two horizontal lines are substantially parallel to the gate lines 121. The chamfered sides are formed at about 45° to the gate lines 121.

Each pixel electrode 191 is provided with three cutting portions: a central cutting portion 91, a lower cutting portion 92a, and an upper cutting portion 92b. The three cutting portions 91, 92a, and 92b partition one pixel electrode 191 into a plurality of sub-areas. The cutting portions 91, 92a, and 92b are almost symmetrically formed with respect to a hypothetical horizontal central line bisecting the pixel electrode 191.

The lower cutting portion 92a is slantingly formed in a left-upward direction from a lower end of the right vertical side of the pixel electrode 191, while the upper cutting portion 92b is slantingly formed in a left-downward direction from an upper end of the right vertical side of the pixel electrode 191. The two cutting portions 92a and 92b are symmetrical to the hypothetical horizontal central line of the pixel electrode 191. The lower cutting portion 92a and the upper cutting portion 92b are formed at 45° to the adjacent gate lines 121, while being perpendicular to each other.

The central cutting portion 91 is formed along the horizontal central line of the pixel electrode 191 and comprises a funnel-shaped opening that is formed inwardly from the right vertical side of the pixel electrode 191 and a horizontal portion extending from the opening. The opening of the central cutting portion 91 has a pair of slanted sides that are substantially parallel to the lower cutting portion 92a and the upper cutting portion 92b, respectively. Accordingly, a lower area of the pixel electrode 191, which is positioned below the hypothetical horizontal central line, is partitioned into two sub-areas by the lower cutting portion 92a, while an upper area of the pixel electrode 191, which is positioned above the hypothetical horizontal central line, is partitioned into two sub-areas by the upper cutting portion 92b. The number of sub-areas or the number of cutting portions may be varied depending on design factors, such as the size of the pixel electrode 191, the length ratio between the vertical side and the horizontal side of the pixel electrode 191, the type of LC in the LC layer 3, and the like.

The contact assistants 81 and 82 are connected to the end portions 129 of the gate lines 121 and the end portions 179 of the data lines 171 through the contact holes 181 and 182, respectively. The contact assistants 81 and 82 supplement adhesion between the exposed end portions 129 and 179 and exterior devices, and protect them.

Each overpass 83 spans the gate line 121 and is connected to the exposed stem line of the storage electrode line 131 and the exposed projection of the free end of the first storage electrode 133a through the contact holes 183a and 183b, respectively. The overpasses 83 and the storage electrode lines 131 having the storage electrodes 133a and 133b may be used to repair defects arising from the gate lines 121, the data lines 171, or the TFTs. In this case, when the gate line 121 and the overpass 83 are connected by, for example, laser irradiation, the metal piece 172 serves as an auxiliary connector therebetween.

Hereinafter, the common electrode panel 200 will be described with reference to FIG. 2 and FIG. 4.

A light-blocking member 220, called “a black matrix”, is provided on an insulating substrate 210 made of transparent glass or plastic. The light-blocking member 220 has as many apertures 225 as the number of the pixel electrodes 191. Each aperture 225 faces one of the pixel electrodes 191, and has substantially the same shape as the pixel electrode 191. The light-blocking member 220 prevents light from leaking through barriers between the pixel electrodes 191. Alternatively, the light-blocking member 220 may consist of portions corresponding to the gate lines 121, the data lines 171, and the TFTs.

A plurality of color filters 230 are formed on the substrate 210 having the light-blocking member 220. Most of the color filters 230 are placed within aperture regions delimited by the light-blocking member 220. The color filters 230 may extend along the pixel electrodes 191 in a vertical direction. Each color filter 230 may exhibit one of red, green, and blue colors.

An overcoat layer 250 is formed on the light-blocking member 220 and the color filters 230 to prevent the color filters 230 from being exposed and to provide a flat surface. The overcoat layer 250 may be made of an organic insulator, and it may be omitted from the LCD.

The common electrode 270 may be made of a transparent conductor such as ITO or IZO and is formed on the overcoat layer 250. The common electrode 270 is provided with multiple groups of three cutting portions. Each group consists of a central cutting portion 71, a lower cutting portion 72a, and an upper cutting portion 72b, and is opposite one of the pixel electrodes 191. The three cutting portions 71, 72a, and 72b are formed in regions corresponding to spaces among the respective cutting portions 91, 92a, and 92 of the pixel electrode 191. In other words, the cutting portions 71, 72a, and 72b are individually positioned between the central cutting portion 91 and the lower and upper cutting portions 92a and 92b, between the chamfered left-lower corner of the pixel electrodes 191 and the lower cutting portion 92a, and between the chamfered left-upper corner of the pixel electrodes 191 and the upper cutting portion 92b. In this structure, each of the cutting portions 71, 72a, and 72b has at least one slanted portion that is parallel to the lower cutting portion 92a or the upper cutting portion 92b of the pixel electrode 191. These cutting portions 71, 72a, and 72b are symmetrical, centering on the hypothetical horizontal central line bisecting the pixel electrode 191.

The lower cutting portion 72a comprises a slanted portion extending in a right-downward direction from the left vertical side of the pixel electrode 191, and a horizontal portion and a vertical portion extending from both ends of the slanted portion, respectively, and forms obtuse angles with respect to the slanted portion.

The upper cutting portion 72b comprises a slanted portion extending in a right-upward direction from the left vertical side of the pixel electrode 191, and a horizontal portion and a vertical portion that extends from both ends of the slanted portion, respectively, and forms obtuse angles with respect to the slanted portion. The horizontal portions and the vertical portions of the lower and upper cutting portions 72a and 72b are formed along an outline of the pixel electrode 191, and are partially overlapped with the pixel electrode 191.

The central cutting portion 71 comprises a horizontal central portion, a pair of slanted portions, and a pair of vertical portions. The horizontal central portion extends along the horizontal central line of the pixel electrode 191 from the left side of the pixel electrode 191. The two slanted portions extend substantially parallel to the two slanted portions of the lower and upper cutting portions 72a and 72b toward the right side of the pixel electrode 191. The two vertical portions of the central cutting portion 71 extend partially along the right side of the pixel electrode 191, starting from both ends of their respective slanted portions. The two vertical portions are overlapped with a portion of the pixel electrode 191, and obtuse angels are formed between the two slanted portions and the two vertical portions of the central cutting portion 71.

The number of cutting portions in the common electrode 270 may be varied depending on design factors, such as the size of the pixel electrode 191, the length ratio between the vertical side and the horizontal side of the pixel electrode 191, the types of LC in the LC layer 3, etc. By overlapping the light-blocking member 220 and the cutting portions 71, 72a, and 72b of the common electrode 270 light is prevented from leaking through the cutting portions 71, 72a, and 72b.

Alignment layers 11 and 21 are individually coated on the inner surfaces of the panels 100 and 200. The alignment layers 11 and 21 may be vertical alignment layers.

Polarizers 12 and 22 are individually attached to the outer surfaces of the panels 100 and 200. Transmission axes of the polarizers 12 and 22 are mutually crossed at a right angle. Here, either of the transmission axes is parallel to the gate lines 121. In, for example, a reflective-type LCD, either of the two polarizers 12 and 22 may be omitted.

The LCD may further include a retardation film (not shown) to compensate for phase retardation in the LC layer 3. Also, a backlight unit (not shown) may be further included in the LCD to supply light to the polarizers 12 and 22, the retardation film, the two panels 100 and 200, and the LC layer 3.

The LC molecules 31 in the LC layer 3 have negative dielectric anisotropy. Thus, in the absence of an electric field, they are aligned substantially perpendicular to the surfaces of the two panels 100 and 200. In this case, incident light cannot pass through the polarizers 12 and 22 whose directions of polarization are mutually perpendicular.

When the common electrode 270 is supplied with a common voltage and the pixel electrode 191 is supplied with a data voltage, an electric field, which is perpendicular to the surfaces of the two panels 100 and 200, is generated in the LC layer 3. In response to the electric field, the LC molecules 31 in the LC layer 3 begin to change their orientation to be perpendicular to the direction of the electric field. Hereinafter, the pixel electrodes 191 and the common electrode 270 will be referred to as field-generating electrodes.

In cooperation with the sides of the pixel electrode 191, the cutting portions 71, 72a, 72b, 91, 92a, and 92b of the field generating electrodes 191 and 270 create horizontal components that determine the tilt directions of the LC molecules 31 in the LC layer 3 by distorting the electric field generated between the field generating electrodes 191 and 270. The horizontal components are substantially perpendicular to the sides of the cutting portions 71, 72a, 72b, 91, 92a, and 92b, and to the sides of the pixel electrode 191.

Referring now to FIG. 3, a group of the cutting portions 71, 72a, 72b, 91, 92a, and 92b partitions one pixel electrode 191 into a plurality of sub-areas. Each sub-area has two main sides, forming slanted angles with respect to main sides of the pixel electrode 191. In this structure, most of the LC molecules 31 tilt in a perpendicular direction to the main sides of the sub-areas. Accordingly, the number of tilt directions of the molecules 31 is about four. In this way, when the LC molecules 31 tilt in various directions, the standard viewing angle of the LCD widens.

At least one of the cutting portions 71, 72a, 72b, 91, 92a, and 92b may be replaced with a protrusion (not shown) or a depression (not shown). In this case, the protrusion may be made of an organic material or an inorganic material, and may be placed on or under the field-generating electrodes 191 and 270. It is to be understood that the form and arrangement of the cutting portions 71, 72a, 72b, 91, 92a, and 92b may be modified.

A plurality of column spacers 320, made of a photoresist material or an insulating material, are provided on the common electrode 270 to insure that the two panels 100 and 200 remain separated by a certain distance over the entire display area. The column spacers 320 are formed in regions corresponding to the light-blocking member 220 of the common electrode panel 200 and the gate lines 121 of the TFT array panel 100, with regular intervals therebetween. For example, the column spacers 320 are disposed only at blue pixels B having the smallest influence on the total brightness, of red, green, and blue RGB pixels. Since the orientations of the LC molecules 31 tend to be disturbed when they are near the column spacers 320, thereby causing, for example, textures, such as light leakage, etc., at these points, an undesirable decrease or increase of the brightness caused by these textures can be minimized by disposing the column spacers 320 only at the blue pixels B. The column spacers 320 may also be disposed at the red pixels R or the green pixels G. However, for the entire display region to show uniform textures, the column spacers 320 are preferably disposed at the same color pixels.

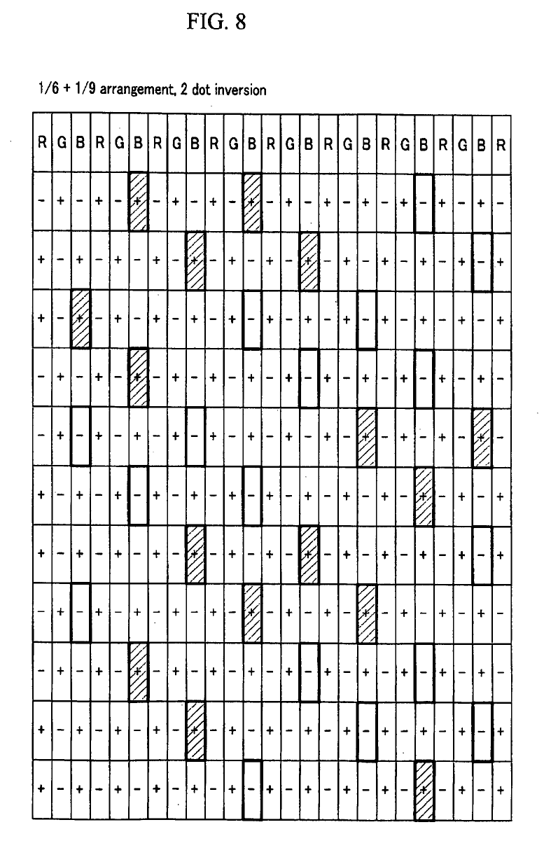

Hereinafter, an arranging method of the column spacers 320 will be discussed with reference to FIG. 8.

FIG. 8 shows polarities of the column spacers 320 alternately arranged at an interval of six pixels and at an interval of nine pixels in a row direction, and polarities of pixels when an LCD operates by 1+2 dot inversion. In this drawing, rectangles outlined by bold lines show pixels with the column spacers 320.

As shown in FIG. 8, in every row of the pixel matrix, the column spacers 320 are alternately disposed at an interval of six pixels and at an interval of nine pixels. For example, in a row of the pixel matrix, the column spacers 320 are arranged in a manner such that a first column spacer 320 is disposed at a sixth pixel from a leftmost pixel, jumping five pixels (e.g., a six pixel-interval arrangement), a second column spacer 320 is disposed at a ninth pixel from the pixel with the first column spacer 320, jumping eight pixels (e.g., a nine pixel-interval arrangement), and the next column spacers are arranged by alternately adopting the six pixel-interval arrangement and the nine pixel-interval arrangement.

The column spacers 320 of adjacent rows miss each other and are individually placed in different columns. All the column spacers 320 arranged in a row of the pixel matrix are positioned to the right by three pixels with respect to the column spacers 320 of an upper row.

The column spacers 320 are disposed only in columns of the blue pixels B. In every column of the pixel matrix, the column spacers 320 are alternately disposed at an interval of two pixels and at an interval of three pixels. For example, in a column, the column spacers 320 are arranged in a manner such that a first column spacer 320 is disposed at a second pixel from an uppermost pixel, jumping one pixel (e.g., a two pixel-interval arrangement), a second column spacer 320 is disposed at a third pixel from the pixel with the first column spacer 320, jumping two pixels (e.g., a three pixel-interval arrangement), and the next column spacers are arranged by alternately adopting the two pixel-interval arrangement and the three pixel-interval arrangement.

The above-mentioned method, in which the six pixel-interval arrangement and the nine pixel-interval arrangement are alternately repeated in every row of the pixel matrix, may be modified. For example, the column spacers may be alternately disposed at an interval of six pixels and at an interval of twelve pixels, or at an interval of nine pixels and at an interval of twelve pixels. However, in all modifications, the column spacers should be alternately disposed only at pixels provided at positions corresponding to multiples of two different numbers that are selected from multiples of three.

If the column spacers 320 are arranged as described above, a striped pattern, which is generated because the texture-remaining time at positive pixels differs from the texture-remaining time at negative pixels, is improved.

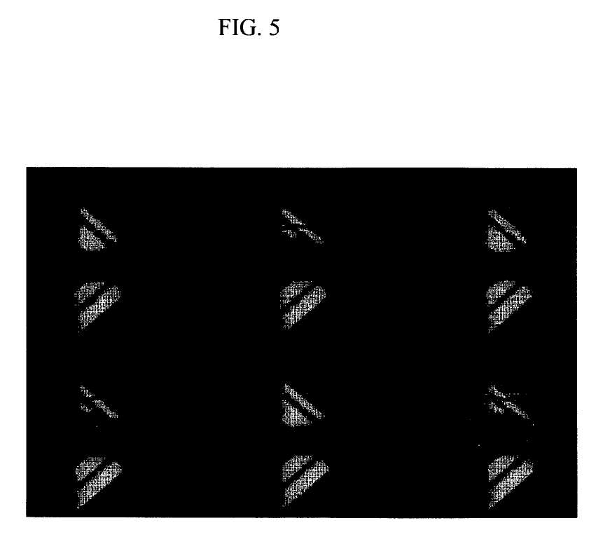

Hereinafter, effects of the improved striped pattern will be described with reference to FIG. 5 and FIG. 8.

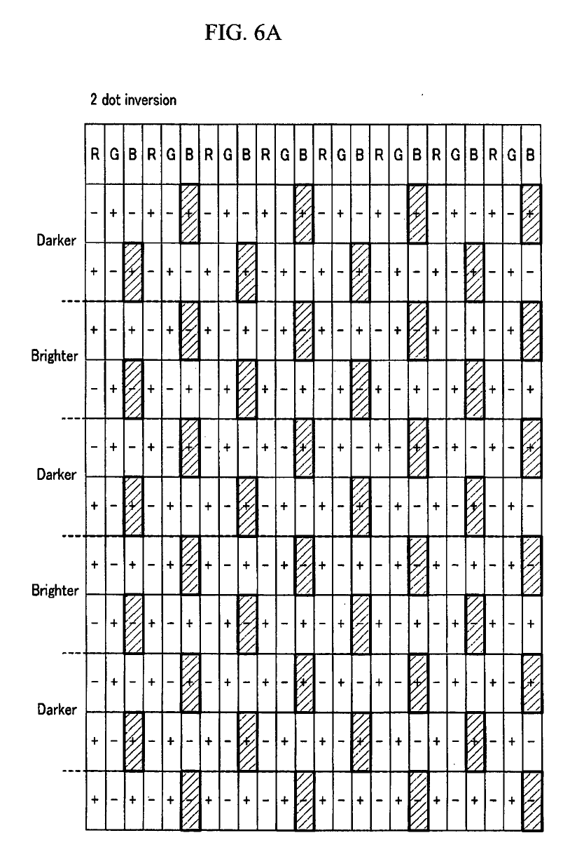

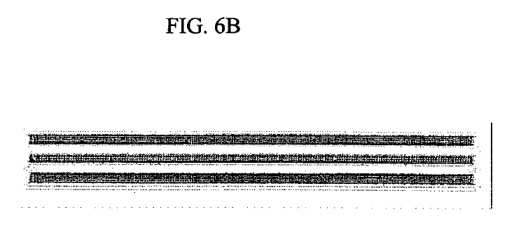

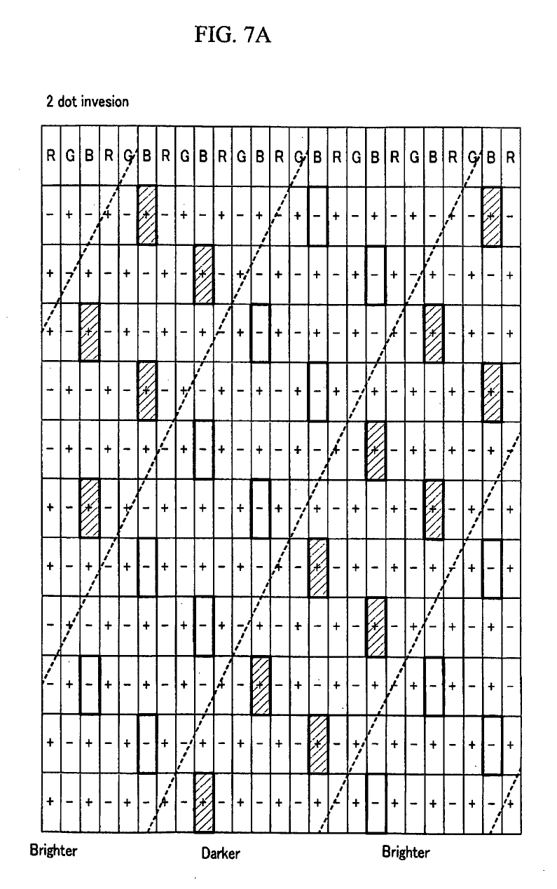

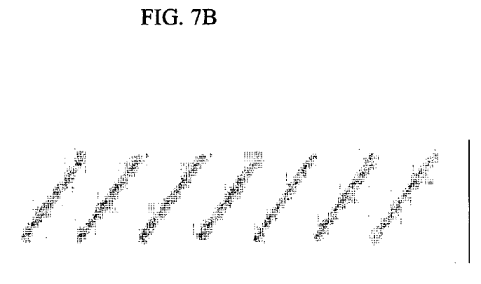

FIG. 5 illustrates textures generated near the column spacers 320 according to another embodiment of the present invention, FIG. 6A shows polarities of column spacers arranged at intervals of six pixels in a row direction and polarities of pixels when an LCD operates by 1+2 dot inversion, FIG. 6B shows stripes originating from the arrangement of FIG. 6A, FIG. 7A shows polarities of column spacers arranged at intervals of nine pixels in a row direction and polarities of pixels when an LCD operates by 1+2 dot inversion, and FIG. 7B shows stripes originating from the arrangement of FIG. 7A.

As shown in FIG. 5, the textures (indicating by circles in each column) that are generated near the column spacers 320 deviate from the light-blocking member 220, thus decreasing the brightness of their respective pixels. These textures gradually disappear as time goes on. However, the textures disappear at different rates for the positive pixels and the negative pixels. Thus, the pixels where the textures remain for a relatively long time are viewed more darkly than the pixels where the textures remain for a relatively short time. As the difference in the brightness between these pixels is very small, it is not easy to recognize when dark pixels and bright pixels are irregularly arranged. However, if the dark pixels and the bright pixels are arranged in a regular or specific pattern, they can be easily viewed.

Referring to FIG. 6A, the column spacers 320 are arranged at intervals of six pixels in a row direction. When an LCD with this arrangement operates by 1+2 dot inversion, polarities of the pixels with the column spacers 320 are changed at intervals of two pixel rows. These changes are viewed as horizontal stripes as shown in FIG. 6B.

Referring to FIG. 7A, the column spacers 320 are arranged at intervals of nine pixels in a row direction. When an LCD with this arrangement operates by 1+2 dot inversion, positive polarity regions and negative polarity regions are alternately formed in a slanted direction. These regions are viewed as slanted stripes as shown in FIG. 6B. In this case, the slanted stripes are fainter than the horizontal stripes of FIG. 6B.

On the other hand, referring to FIG. 8, the column spacers 320 are alternately arranged at an interval of six pixels and at an interval of nine pixels in a row direction. When an LCD with this arrangement operates by 1+2 dot inversion, the positive polarity regions and negative polarity regions are irregularly mixed. In this case, a specific pattern is not shown.

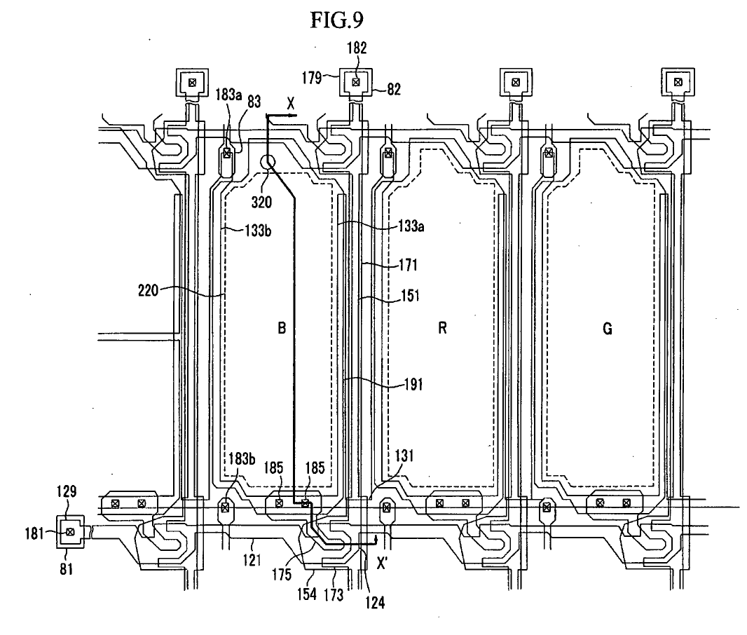

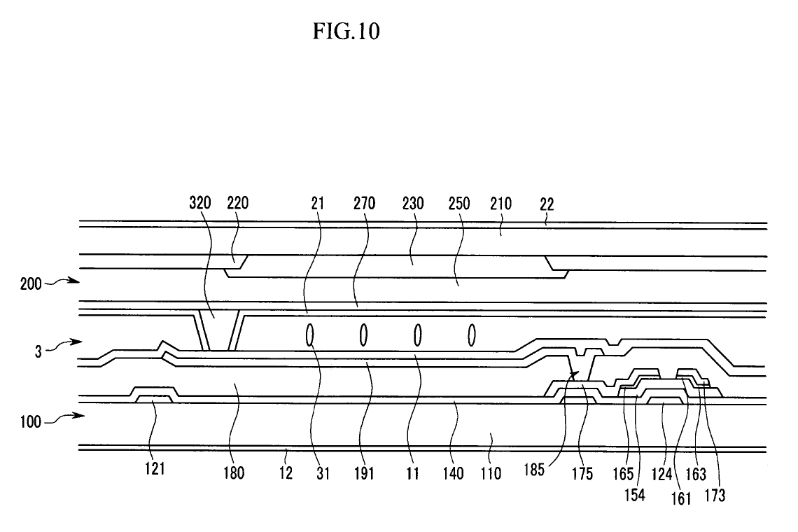

In the above-described embodiment, the column spacers 320 are formed in regions corresponding to the gate lines 121 of the TFT array panel 100. An LCD with column spacers arranged at flat portions of the pixels will be described with reference to FIG. 9 and FIG. 10.

FIG. 9 is a layout view of an LCD according to another embodiment of the present invention and FIG. 10 is a cross-sectional view taken along line X-X′ of FIG. 9.

A TFT array panel employed in an LCD according to another embodiment of the present invention is configured as follows.

Referring to FIG. 9 and FIG. 10, a plurality of gate lines 121 and a plurality of storage electrode lines 131 are formed on an insulating substrate 110 made of transparent glass or plastic.

The gate lines 121 for transmitting gate signals extend substantially in a horizontal direction. Each gate line 121 includes a plurality of gate electrodes 124 protruding downward and an end portion 129 having a relatively large size to be connected to a different layer or an external device. Gate drivers (not shown) for generating the gate signals may be mounted on a flexible printed circuit film (not shown) attached to the substrate 110, or directly on the substrate 110. Otherwise, the gate drivers may be integrated into the substrate 110. In this case, the gate lines 121 are directly connected to the gate drivers.

The storage electrode lines 131 receive a predetermined voltage. Each storage electrode line 131 includes a stem line that is substantially parallel to the gate lines 121 and multiple pairs of storage electrodes 133a and 133b that extend from the stem line substantially in a vertical direction. Each storage electrode line 131 is placed between two adjacent gate lines 121. The stem line of the storage electrode line 131 is closer to the lower gate line of the two. Each storage electrode 133a has a fixed end, connected to one of the stem lines, and a free end. Each storage electrode 133b has a fixed end with a relatively large size, which is connected to one of the stem lines, and a slightly curved free end. It is to be understood however that the form and arrangement of the storage electrode lines 131 may be varied.

The gate lines 121 and the storage electrode lines 131 are made of an aluminum—(Al) containing metal such as Al and an Al alloy, a silver—(Ag) containing metal such as Ag and a Ag alloy, a copper—(Cu) containing metal such as Cu and a Cu alloy, a molybdenum—(Mo) containing metal such as Mo and a Mo alloy, chrome (Cr), titanium (Ti), or tantalum (Ta). The gate lines 121 and the storage electrode lines 131 may be configured as a multi-layered structure, in which at least two conductive layers (not shown) having different physical properties are included. In such a structure, one of the two conductive layers is made of a low resistivity metal, such as an Al-containing metal, a Ag-containing metal, a Cu-containing metal, or the like, to reduce a delay of the signals or voltage drop in the gate lines 121 and the storage electrode lines 131. The other layer is made of a good material having physical, chemical, and electrical contact properties with other materials such as indium tin oxide (ITO) and indium zinc oxide (IZO). For example, a Mo-containing metal, Cr, Ta, Ti, etc., may be used for the formation of the layer. Examples of the combination of the two layers are a lower Cr layer and an upper Al (or Al alloy) layer, and a lower Al (or Al alloy) layer and an upper Mo (or Mo alloy) layer. In addition to the above-listed materials, various metals and conductors can be used for the formation of the gate lines 121 and the storage electrode lines 131.

All lateral sides of the gate lines 121 and the storage electrode lines 131.slope in the range from about 30° to 80° to the surface of the substrate 110.

A gate insulating layer 140 made of silicon nitride (SiNx) or silicon oxide (SiO₂), is formed on the gate lines 121 and the storage electrode lines 131.

A plurality of linear semiconductors 151 made of hydrogenated amorphous silicon (abbreviated as “a-Si”) or polysilicon are formed on the gate insulating layer 140. Each linear semiconductor 151 extends substantially in a vertical direction, and includes a plurality of projections 154 that extend along respective gate electrodes 124. The linear semiconductors 151 are enlarged near the gate lines 121 and the storage electrode lines 131 by the projections 154 to cover them.

A plurality of linear ohmic contacts 161 and island-shaped ohmic contacts 165 are formed on the linear semiconductors 151. The ohmic contacts 161 and 165 may be made of N+ hydrogenated amorphous silicon that is highly doped with N-type impurities such as phosphorus (P), or silicide. The linear ohmic contacts 161 include a plurality of projections 163. A set of a projection 163 and an island-shaped ohmic contact 165 is placed on the projection 154 of the semiconductor 151.

All lateral sides of the linear semiconductors 151 and the ohmic contacts 161 and 165 slope in the range from about 30° to 80° to the surface of the substrate 110.

A plurality of data lines 171 and a plurality of drain electrodes 175 are formed on the ohmic contacts 161 and 165 and the gate insulating layer 140.

The data lines 171 for transmitting data signals extend substantially in a vertical direction to be crossed with the gate lines 121 and the stem lines of the storage electrode lines 131. At this time, each pair of the storage electrodes 133a and 133b is placed between two adjacent data lines 171. Each data line 171 includes a plurality of source electrodes 173 extending toward their respective gate electrodes 124, and an end portion 179 having a relatively large size to be connected to a different layer or an external device. Data drivers (not shown) for generating the data signals may be mounted on a flexible printed circuit film (not shown) attached to the substrate 110, or directly on the substrate 110. Otherwise, the data drivers may be integrated into the substrate 110. In this case, the data lines 171 are directly connected to the gate drivers.

The drain electrodes 175 are separated from the data lines 171 and are opposite the source electrodes 173 centering on the gate electrodes 124. Each drain electrode 175 includes an expansion having a relatively large size and a bar-shaped end portion that is partially surrounded with the source electrode 173 having the shape of a “U” rotated 90° counter-clockwise.

A gate electrode 124, a source electrode 173, a drain electrode 175, and a projection 154 of the semiconductor 151 form a thin film transistor (TFT). A TFT channel is formed in the projection 154 provided between the source electrode 173 and the drain electrode 175.

The data lines 171 and the drain electrodes 175 are made of a refractory metal such as Mo, Cr, Ta, or Ti, or alloys thereof, and may be configured as multi-layered structures including a refractory metal layer (not shown) and a low resistivity conductive layer (not shown). An example of the multi-layered structure is a lower layer made of one of Cr, Mo, and a Mo alloy, and an upper layer made of Al or an Al alloy. Another example is a lower layer made of Mo or a Mo alloy, an intermediate layer made of Al or an Al alloy, and an upper layer made of Mo or a Mo alloy. In addition to the above-listed materials, various metals and conductors can be used for the formation of the data lines 171 and the drain electrodes 175.

All lateral sides of the data lines 171 and the drain electrodes 175 slope in the range from about 30° to 80° to the surface of the substrate 110.

The ohmic contacts 161 and 165 exist only between the underlying semiconductors 151 and the overlying data lines 171 and between the overlying drain electrodes 175 and the underlying semiconductors 151, to reduce contact resistance therebetween. Most portions of the linear semiconductors 151 are formed more narrowly than the data lines 171, but some portions thereof are enlarged in areas to be crossed with the gate lines 121 or the storage electrode lines 131 to prevent the data lines 171 from disconnecting. The linear semiconductors 151 are partially exposed in areas where the data lines 171 and the drain electrodes 175 do not cover them, as well as between the source electrodes 173 and the drain electrodes 175.

A passivation layer 180 is formed on the data lines 171, the drain electrodes 175, and the exposed portions of the semiconductors 151. A top surface of the passivation layer 180 may be planarized. The passivation layer 180 may be configured as a single layer made of an inorganic insulator, such as SiNx orSiO₂, an organic insulator, or a low dielectric insulator. In this case, a dielectric constant of the organic insulator and the low dielectric insulator is below 4.0, and the low dielectric insulator can be selected from a-Si:C:O, a-Si:O:F, etc., which are produced by plasma enhanced chemical vapor deposition (PECVD). The organic insulator may have photosensitivity. The passivation layer 180 may also be configured as a double-layered structure including a lower inorganic insulator layer and an upper organic insulator layer. This double-layered structure maintains a good insulating property of the organic layer, and protects the exposed portions of the semiconductors 151 from damage.

The passivation layer 180 is provided with a plurality of contact holes 182 and 185, through which the end portions 179 of the data lines 171 and the expansions of the drain electrodes 175 are exposed, respectively. A plurality of contact holes 181 are formed in the passivation layer 180 and the gate insulating layer 140, and the end portions 129 of the gate lines 121 are exposed therethrough. A plurality of contact holes 183a and 183b are formed in the passivation layer 180 and the gate insulating layer 140 to expose straight portions of the free ends of the storage electrodes 133a, and the portions of the stem lines of the storage electrode line 131, which are adjacent to the fixed ends of the storage electrode lines 133a.

A plurality of pixel electrodes 191, a plurality of overpasses 83, and a plurality of contact assistants 81 and 82 are formed on the passivation layer 180. They may be made of a transparent conductor, such as ITO or IZO, or a reflective metal, such as Al, Ag, Cr, or their alloys.

The pixel electrodes 191 are physically and electrically connected to the drain electrodes 175 through the contact holes 185 to receive data voltages from the drain electrodes 175. The pixel electrodes 191 supplied with the data voltages generate electric fields in cooperation with a common electrode 270 of a common electrode panel 200, thereby determining the orientations of LC molecules 31 in the LC layer 3 interposed between the two electrodes 191 and 270. According to the orientations of the LC molecules 31, the polarization of light passing through the LC layer 3 is varied. Each set of the pixel electrode 191 and the common electrode 270 forms an LC capacitor that is capable of storing an applied voltage after the TFT is turned off.

The pixel electrodes 191 are overlapped with the storage electrodes 133a and 133b as well as the stem lines of the storage electrodes 131. To enhance the voltage storage capability of the LC capacitors, storage capacitors are provided. The storage capacitors are implemented by overlapping the pixel electrodes 191 and the drain electrodes 175 electrically connected thereto with the storage electrode lines 131.

The contact assistants 81 and 82 are connected to the end portions 129 of the gate lines 121 and the end portions 179 of the data lines 171 through the contact holes 181 and 182, respectively. The contact assistants 81 and 82 supplement adhesion between the exposed end portions 129 and 179 and exterior devices, and protect them.

Each overpass 83 spans the gate line 121 and is connected to the exposed stem line of the storage electrode line 131 and the exposed projection of the free end of the storage electrode 133b through the contact holes 183a and 183b. The overpasses 83 and the storage electrode lines 131 having the storage electrodes 133a and 133b may be used for repairing defects arising from the gate lines 121, the data lines 171, or the TFTs.

A common electrode panel 200 employed in an LCD according to another embodiment of the present invention is configured as follows.

A light-blocking member 220, also called “a black matrix”, is provided on an insulating substrate 210 facing the substrate 110 of the TFT array panel 100. The light-blocking member 220 consists of portions corresponding to the gate lines 121 and the data lines 171 that define aperture regions corresponding to the pixels surrounded with the gate lines 121 and the data lines 171. The light-blocking member 220 is made of an organic material including black pigments and prevents light from leaking through barriers between the pixels. The light-blocking member 220 is also disposed at the circumference of a display region that is an aggregate of the pixels and displays images, to prevent light from leaking through the circumference of the display region. In addition, the light-blocking member 220 is formed on the TFTs to prevent exterior light from entering the semiconductors 151 of the TFTs.

A plurality of red, green, and blue (RGB) color filters 230 are formed on the substrate 210 having the light-blocking member 220. In this case, each of the RGB color filters 230 is positioned at a place corresponding to a set of RGB pixels. The RGB color filters 230 extend in a vertical direction. The barriers between the color filters 230 are placed on the light-blocking member 220 to prevent light from leaking therethrough. In still another embodiment, the circumferences of adjacent color filters 230 and pixels are overlapped with each other to prevent light leakage.

An overcoat layer 250, made of an insulating material, is formed on the RGB color filters 230.

The common electrode 270, made of a transparent conductor such as ITO or IZO, is formed on the overcoat layer 250. The common electrode 270 supplied with a common voltage generates electric fields in cooperation with the pixel electrodes 191 supplied with the data voltages, and determines the orientations of LC molecules 31 in the LC layer 3 interposed between the two electrodes 191 and 270.

A plurality of column spacers 320, made of an insulating material, are formed between the TFT array panel 100 and the common electrode panel 200 to maintain a uniform distance (e.g., a cell gap) between the two panels 100 and 200. The column spacers 320 are disposed near of the circumferences of the pixels surrounded with the gate lines 121 and the data lines 171. In this case, the column spacers 320 are overlapped with the light-blocking member 220, while not overlapping the signal lines, such as the gate lines 121, the data lines 171, the storage electrode lines 131, etc. The aperture regions of the light-blocking member 220, which are defined by dashed lines in FIG. 9, correspond to transmissive areas of the pixels, through which light is freely transmitted. In this structure, the column spacers 320 are disposed only at the blue pixels B of the RGB pixels.

In this embodiment, the column spacers 320 are not formed on the gate lines 121 and the data lines 171. Instead, the column spacers 320 are formed on the flat circumferences of the pixels surrounded with the gate lines 121 and the data lines 171. Accordingly, when the column spacers 320 slip from their positions due to an external pressure or shock, they can be easily restored to their original positions.

Alignment layers 11 and 21 are individually formed on inner surface of the two panels 100 and 200 to align the LC molecules 31 in the LC layer 3, and polarizers 12 and 22 are individually attached to outer surfaces of the two panels 100 and 200.

As mentioned above, the column spacers 320 may be formed in the pixels surrounded with the gate lines 121 and the data lines 171. In this case, in every row of the pixel matrix, the column spacers 320 are alternately formed only at pixels provided at positions corresponding to multiples of two different numbers that are selected from multiples of three. For example, the column spacers 320 may be alternately disposed at an interval of six pixels and at an interval of nine pixels in every row of the pixel matrix as shown, for example, in FIG. 8.

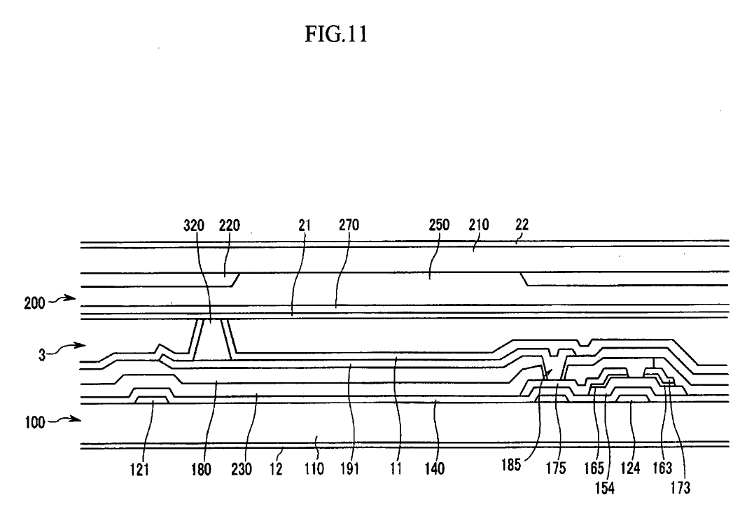

FIG. 11 is a cross-sectional view of an LCD according to still another embodiment of the present invention.

A TFT array panel 100 of FIG. 11 includes the same or similar components as the TFT array panels of FIGS. 4 and 10, therefore detailed descriptions thereof are omitted.

As shown in FIG. 11, a vertical profile of the TFT array panel 100 of this embodiment is substantially the same as that of FIG. 10, except that the column spacers 320 are formed on the TFT array panel 100. In addition, the RGB color filters 230 are formed under the passivation layer 180. In this structure, barriers between the color filters 230 are overlapped with the data lines 171 to prevent light from leaking through the barriers. In other words, overlap portions between the color filters 230 and the data lines 171 serve as light-blocking members.

In accordance with an exemplary embodiment of the present invention, an LCD including spacers arranged at varying intervals is provided. The arrangement of the spacers enables the LCD to maintain a uniform distance between two panels over an entire display area thereby allowing the LCD to display high quality images.

While the present invention has been described in detail with reference to the exemplary embodiments, it is to be understood by those of ordinary skill in the art that various changes in form and details may be made therein without departing from the spirit and scope of the present invention as defined by the appended claims.

What is claimed is:

1. A liquid crystal display, comprising:
a first insulating substrate;
a second insulating substrate facing the first insulating substrate;
a first field-generating electrode that is formed on one of the first substrate and the second substrate;
a second field-generating electrode that is formed on one of the first substrate and the second substrate and that defines a plurality of pixels, arranged substantially in a matrix;
a liquid crystal layer interposed between the first substrate and the second substrate; and
a plurality of spacers that are formed on one of the first substrate and the second substrate to maintain a distance between the first and second substrates,
wherein the spacers are alternately disposed in a first interval and a second interval in every row of the matrix.

2. The liquid crystal display of claim 1, wherein the spacers are disposed only at pixels corresponding to multiples of two different numbers that are selected from multiples of three.

3. The liquid crystal display of claim 2, wherein the first interval is an interval of six pixels, and the second interval is an interval of nine pixels.

4. The liquid crystal display of claim 1, wherein spacers of adjacent rows are placed in different columns of the matrix.

5. The liquid crystal display of claim 1, further comprising:
a plurality of red, green, and blue color filters that are formed on one of the first substrate and the second substrate,
wherein the spacers are formed in regions corresponding to the blue filters.

6. The liquid crystal display of claim 1, wherein the liquid crystal display operates by 1+2 dot inversion.

7. The liquid crystal display of claim 1, further comprising:
a gate line formed on the first substrate;
a data line formed on the first substrate;
a thin film transistor that is connected to the gate line, the data line, and the first field generating electrode;
a first domain-partitioning member formed on the first substrate; and
a second domain-partitioning member formed on the second substrate.

8. The liquid crystal display of claim 7, wherein the first domain-partitioning member is a cutting portion formed in the first field-generating electrode and the second domain-partitioning member is a cutting portion formed in the second field-generating electrode.

9. The liquid crystal display of claim 7, wherein the first domain-partitioning member and the second domain-partitioning member are formed at about ±45 degrees to the gate line.

10. The liquid crystal display of claim 7, wherein the first domain-partitioning member is a protrusion formed in the first field-generating electrode and the second domain-partitioning member is a protrusion formed in the second field-generating electrode.

11. The liquid crystal display of claim 1, wherein the spacers are column spacers.

12. The liquid crystal display of claim 1, further comprising;
a gate line formed on the first substrate;
a data line formed on the first substrate; and
a thin film transistor that is connected to the gate line, the data line, and the first field-generating electrode,
wherein the spacers are formed in regions corresponding to one of the gate line and the data line.

13. The liquid crystal display of claim 1, further comprising;
a gate line formed on the first substrate;
a data line formed on the first substrate; and
a thin film transistor that is connected to the gate line, the data line, and the field-generating electrode,
wherein the spacers are formed in regions corresponding to portions of the pixels surrounded with the gate line and the data line.

14. The liquid crystal display of claim 1, wherein the first field-generating electrode is a pixel electrode and the second field-generating electrode is a common electrode.

15. A liquid crystal display, comprising:
a first insulating substrate;
a plurality of gate lines formed on the first substrate;
a plurality of data lines that are formed on the first substrate and crossed with the gate lines to define pixels that are arranged in a matrix;
a plurality of thin film transistors, each of which is connected one of the gate lines and one of the data lines:
a plurality of pixel electrodes, each of which is connected to one of the thin film transistors;
a second insulating substrate;
a light-blocking member formed on the second substrate;
a plurality of color filters formed on the light-blocking member;
a common electrode formed on the color filters; and
a plurality of spacers that are formed on one of the first substrate and the second substrate to maintain a uniform distance between the first and second substrates,
wherein the spacers are alternately disposed in a first interval and a second interval in every row of the matrix.

16. The liquid crystal display of claim 15, wherein the spacers are disposed only at pixels corresponding to multiples of two different numbers that are selected from multiples of three.

17. The liquid crystal display of claim 16, wherein the first interval is an interval of six pixels, and the second interval is an interval of nine pixels.

18. The liquid crystal display of claim 15, wherein spacers of adjacent rows are placed in different columns of the matrix.

19. The liquid crystal display of claim 15, wherein the spacers are formed in regions corresponding to the gate lines or the data lines.

20. The liquid crystal display of claim 15, wherein the spacers are formed in regions corresponding to portions of the pixels surrounded with the gate lines and the data lines.
